(19) United States
(12) Patent Application Publication
(10) Pub. No.: US 2012/0022928 A1
(43) Pub. Date: Jan. 26, 2012

(54) SYSTEM AND METHOD FOR VIRTUAL RESOURCE AND LOCATION-BASED ADVERTISEMENT

(76) Inventor: Richard Wu, Brooklyn, NY (US)

(21) Appl. No.: 12/843,248

(22) Filed: Jul. 26, 2010

(51) Int. Cl. G06Q 30/00; G01S 19/42

(52) U.S. Cl. 705/14.12; 705/14.58; 342/357.25

(57) ABSTRACT

A system and method for virtual resource and location-based advertisement, including obtaining at least one advertisement including an offer including an exchange of virtual resources from at least one advertiser, obtaining at least one advertiser location of the at least one advertiser, receiving a user location and a selected keyword from a user, determining at least one selected offer associated with the selected keyword based on a distance between the user location and the at least one advertiser location, where the at least one selected offer includes an exchange of at least one selected virtual resource from at least one selected advertiser, and providing the at least one selected offer, the at least one selected advertiser associated with the at least one selected offer, and at least one selected advertiser location associated with the at least one selected advertiser to the user.

### BACKGROUND OF THE INVENTION

1. Field of the Invention

Embodiments of the invention described herein pertain to the field of computer systems. More particularly, but not by way of limitation, one or more embodiments of the invention enable systems and methods for virtual resource and location-based advertisement.

2. Description of the Related Art

Due to the growth of the Internet and other computer technologies, an increasing number of human activities are handled electronically. Computers are used for commercial interaction, recreation, marketing, and many other activities.

Real-world resources are often represented electronically, such as accounts, money, stocks, and other assets and resources. Virtual resources are also represented electronically. Virtual resources may be associated with one or more software applications. For example, a game application may include in-game resources.

Systems and methods have been developed to support secure electronic transactions involving real-world resources. However, transactions involving virtual resources have been generally limited to other virtual transactions, money-based transactions, and limited transactions designated by the application associated with the virtual resource.

Virtual resources are often combined with online advertisement and incentives. However, virtual resources are not generally available for with real-world advertisement or incentives. This is especially true outside of promotional agreements between a third party advertiser and the owner of an application associated with the virtual resource. Furthermore, no centralized system exists which provides virtual resource and location-based advertisement.

### BRIEF SUMMARY OF THE INVENTION

One or more embodiments described herein enable a computer-readable medium having computer-readable instructions for virtual resource and location-based advertisement. Execution of the computer-readable instructions by one or more processors causes the one or more processors to carry out the step of associating at least one keyword with at least one virtual resource in at least one application. An automatically generated keyword may be automatically associated with a virtual resource based on a virtual resource identifier. A requested keyword may be is associated with a requested virtual resource based on a request by a requesting advertiser.

In one or more embodiments, the at least one virtual resource includes at least one in-game resource, where the at least one application includes at least one game.

Execution of the computer-readable instructions by one or more processors further causes the one or more processors to carry out the step of obtaining at least one advertisement including an offer. The offer includes an exchange of virtual resources.

Execution of the computer-readable instructions by one or more processors further causes the one or more processors to carry out the step of obtaining at least one advertiser location of the at least one advertiser.

Execution of the computer-readable instructions by one or more processors further causes the one or more processors to carry out the step of receiving a user location and a selected keyword from a user. In one or more embodiments, the user location is periodically received from a GPS-enabled mobile device.

Execution of the computer-readable instructions by one or more processors further causes the one or more processors to carry out the step of determining at least one selected offer associated with the selected keyword. The determining at least one selected offer is based on a distance between the user location and the at least one advertiser location. The at least one selected offer includes an exchange of at least one selected virtual resource from at least one selected advertiser.

Execution of the computer-readable instructions by one or more processors further causes the one or more processors to carry out the step of providing the at least one selected offer, the at least one selected advertiser associated with the at least one selected offer, and at least one selected advertiser location associated with the at least one selected advertiser to the user.

In one or more embodiments, determining the at least one selected offer further includes determining if a virtual resource level of the user for a virtual resource associated with an offer is non-zero.

In one or more embodiments, determining the at least one selected offer further includes determining if a virtual resource level of the user for a virtual resource associated with an offer is at least an amount specified by the offer.

The offer may include an exchange of at least one specified virtual resource for at least one of goods and services, an exchange of at least one specified virtual resource for a discount on least one of goods and services, an exchange of at least one specified virtual resource for a chance to win at least one of goods, services, discounts and other prizes, an exchange of at least one specified virtual resource for visiting an associated advertiser location by the user, an exchange of at least one specified virtual resource for visiting a virtual location by the user, an exchange of at least one specified virtual resource for viewing an advertisement by the user, and/or an exchange of at least one specified virtual resource for providing user information to an associated advertiser.

Visiting an associated advertiser location by a user may be automatically detected by location information received from the user. In one or more embodiments, visiting an associated advertiser location by a user is tracked using a token distributed to the user at the associated advertiser location.

One or more embodiments described herein enable a computer-readable medium having computer-readable instructions for virtual resource and location-based advertisement. In one or more embodiments, the computer-readable instructions are configured to execute a client program to carry out the steps on a mobile device.

Execution of the computer-readable instructions by one or more processors further causes the one or more processors to carry out the step of accepting user input including a keyword in a search field from a user.

Execution of the computer-readable instructions by one or more processors further causes the one or more processors to carry out the step of providing the keyword over a network.

Execution of the computer-readable instructions by one or more processors further causes the one or more processors to carry out the step of providing authentication information over the network, where the authentication information enables access to at least one user virtual resource level of a virtual resource in an application including the virtual resource.

Execution of the computer-readable instructions by one or more processors further causes the one or more processors to carry out the step of determining a user location.

Execution of the computer-readable instructions by one or more processors further causes the one or more processors to carry out the step of providing the user location over the network.

Execution of the computer-readable instructions by one or more processors further causes the one or more processors to carry out the step of obtaining at least one selected advertiser over the network, where the at least one selected advertiser is determined based on the keyword and the user location.

Execution of the computer-readable instructions by one or more processors further causes the one or more processors to carry out the step of obtaining at least one selected advertiser location over the network.

Execution of the computer-readable instructions by one or more processors further causes the one or more processors to carry out the step of obtaining at least one selected offer associated with the at least one selected advertiser. The at least one selected offer includes an offer to exchange at least one selected virtual resource associated with the keyword.

Execution of the computer-readable instructions by one or more processors further causes the one or more processors to carry out the step of displaying the at least one selected advertiser to the user on a map based on the at least one selected advertiser location. In one or more embodiments, the computer-readable instructions are configured to execute as an extension of an existing mapping application.

Execution of the computer-readable instructions by one or more processors further causes the one or more processors to carry out the step of displaying the at least one selected offer to the user.

One or more embodiments described herein enable a system for associating virtual resource and location-based advertisement. The system for associating virtual resource and location-based advertisement includes a virtual resource data store including a computer database configured to store data including a plurality of users, a plurality of applications associated with the plurality of users, a plurality of virtual resources associated with the plurality of applications, a plurality of keywords associated the plurality of virtual resources, a plurality of advertisements associated with the plurality of keywords and the plurality of virtual resources, and a plurality of advertisers associated with the plurality of advertisements, where each of the plurality of advertisers include at least one advertiser location.

The system for associating virtual resource and location-based advertisement further includes at least one processor.

The system for associating virtual resource and location-based advertisement further includes a network interface device configured to communicate with a plurality of user devices over a network.

The system for associating virtual resource and location-based advertisement further includes an advertisement module including a computer-readable medium including computer-readable instructions, where execution of the computer-readable instructions by the at least one processor causes the at least one processor to obtain at least one advertisement including an offer including an exchange of virtual resources from at least one advertiser, and obtain at least one advertiser location of the at least one advertiser.

The system for associating virtual resource and location-based advertisement further includes a user search module including a computer-readable medium including computer-readable instructions. Execution of the computer-readable instructions by the at least one processor causes the at least one processor to receive user identification information, a user location and a selected keyword from a user device.

Execution of the computer-readable instructions by the at least one processor further causes the at least one processor to obtain data from the computer database including at least one selected virtual resource level associated with at least one selected virtual resource, where the at least one selected virtual resource is associated with the selected keyword.

Execution of the computer-readable instructions by the at least one processor further causes the at least one processor to obtain data from the computer database including at least one selected advertiser associated with the selected keyword based on a distance between the user location and the at least one advertiser location.

Execution of the computer-readable instructions by the at least one processor further causes the at least one processor to obtain data from the computer database including at least one selected offer associated with the at least one selected advertiser and the selected keyword.

Execution of the computer-readable instructions by the at least one processor further causes the at least one processor to provide the at least one selected offer, the at least one selected advertiser and at least one selected advertiser location associated with the at least one selected advertiser to the user device.

### BRIEF DESCRIPTION OF THE DRAWINGS

The above and other aspects, features and advantages of the invention will be more apparent from the following more particular description thereof, presented in conjunction with the following drawings wherein:

FIG. 1 illustrates a general-purpose computer and peripherals that when programmed as described herein may operate as a specially programmed computer capable of implementing one or more systems and methods for virtual resource and location-based advertisement.

FIG. 2 illustrates a system diagram in accordance with systems and methods for virtual resource and location-based advertisement.

FIG. 3 illustrates an exemplary entity relationship diagram in accordance with systems and methods for virtual resource and location-based advertisement.

FIG. 4 is a flowchart of an exemplary process for accepting advertisements in accordance with systems and methods for virtual resource and location-based advertisement.

FIG. 5 is a flowchart of an exemplary process for providing location-based keyword advertisements in accordance with systems and methods for virtual resource and location-based advertisement.

FIG. 6 is a flowchart of an exemplary process for location-based keyword searching in accordance with systems and methods for virtual resource and location-based advertisement.

FIGS. 7A-B illustrate an exemplary user interface in accordance with systems and methods for virtual resource and location-based advertisement.

### DETAILED DESCRIPTION

Systems and methods for providing search engine optimization analysis will now be described. In the following exemplary description numerous specific details are set forth in order to provide a more thorough understanding of embodiments of the systems and methods described. It will be apparent, however, to one of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

As used herein, the term “virtual resource” refers to any stored electronic representation of an item, including a quantity, where the item and quantity do not directly represent a quantity of a tangible item.

As used herein, the term “goods and services” refers to any combination of goods and/or services. As used herein, the term “goods” refers to any tangible item. I used herein, the term “services” refers to any duty or labor performed, including but not limited to providing knowledge, expertise, assistance, labor, and any other act.

As used herein, the term “exchange” refers to any transaction involving the item exchanged.

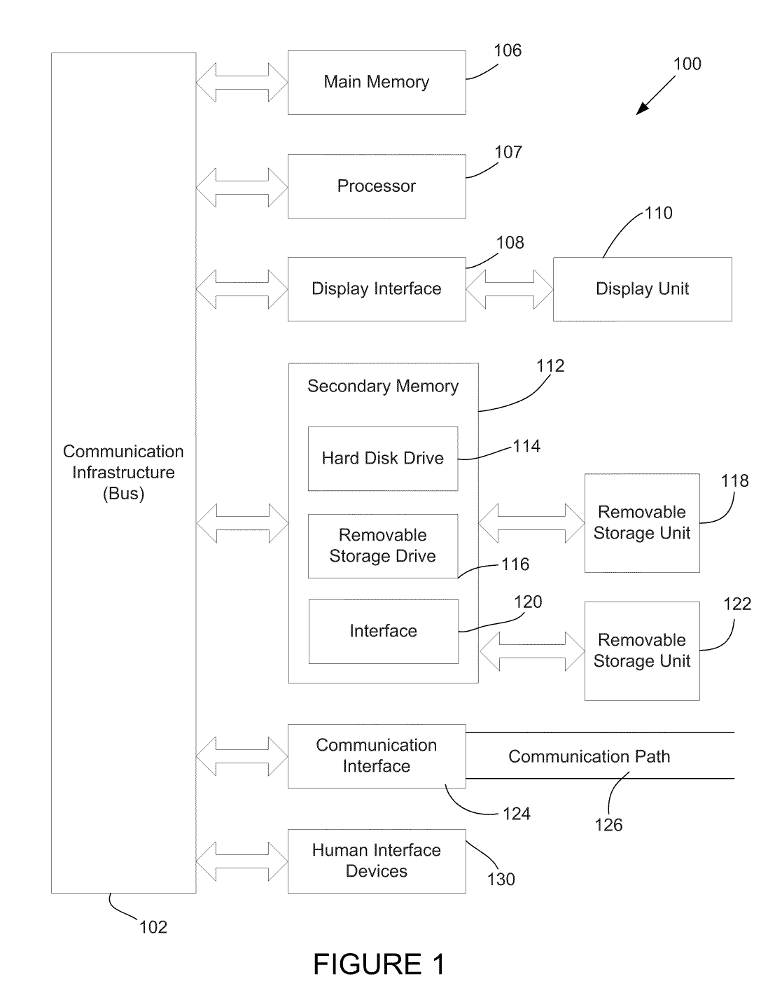

FIG. 1 diagrams a system 100 including a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may include one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may include, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also include interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Computer networks such Local Area Networks (LAN), Wide Area Networks (WAN), wireless networks, optical networks, distributed networks, the Internet or any combination thereof are some examples of the type of communication paths that may be utilized by the specially program computer system. Communication path 126 may include any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may include a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. Where a virtual machine, process, device or otherwise performs substantially similarly to that of a physical computer system, such a virtual platform will also fall within the scope of disclosure provided herein, notwithstanding the description herein of a physical system such as that in FIG. 1.

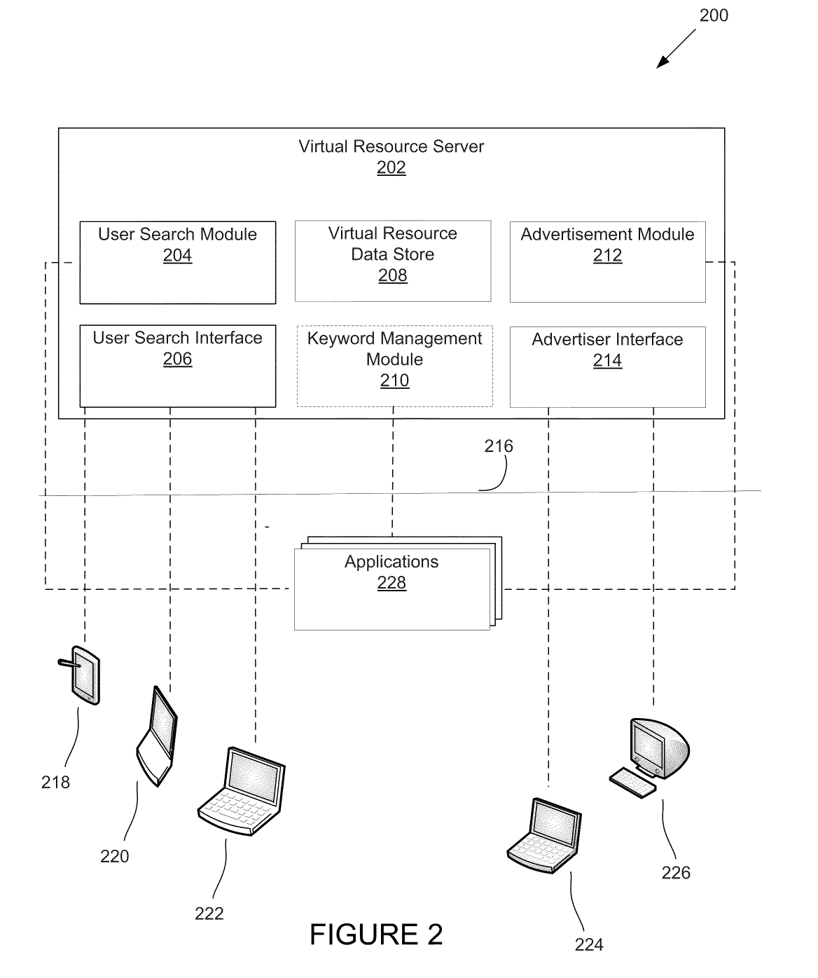

FIG. 2 illustrates a system diagram in accordance with systems and methods for virtual resource and location-based advertisement. Virtual resource advertisement system 200 includes virtual resource server 202. Virtual resource server 202 may include one or more computers, including one or more general-purpose computer and peripherals shown in FIG. 1.

Virtual resource server 202 is configured to communicate over network 216. Network 216 may include at least one network selected from wired networks including local area networks and wide area networks, wireless networks including telecommunications networks, optical networks, distributed networks, the Internet or any combination thereof.

Virtual resource server 202 includes user search module 204, users search interface 206, virtual resource data store 208, advertisement module 212, advertiser interface 214, and optionally, keyword management module 210. These components of virtual resource server 202 may communicate with each other over a network, such as network 216, and/or a direct connection, such as any bidirectional communication infrastructure, including communication infrastructure system bus 102. Furthermore, these components of virtual resource server 202 may be implemented as one or more dependent or independent software applications.

Virtual resource advertisement system 200 includes at least one application 228. Applications 228 may include any third-party application with respect to virtual resource server 202. Applications 228 include one or more virtual resources. In one or more embodiments, applications 228 are connected to virtual resource server 202 via network 216.

Applications 228 may require authentication information for a user in order to obtain one or more virtual resource levels for the user. In one or more embodiments, virtual resource server 202 has access to virtual resource level information for users of applications 228 without requiring authentication from each user. Applications 228 may push updated virtual resource level information to virtual resource server 202, such as according to a schedule, at a regular time period, or when an update is made to a virtual resource level. Virtual resource server 202 may also query applications 228 for virtual resource level information for each user.

Virtual resource server 202 includes virtual resource data store 208. Virtual resource data store 208 is configured to manage any information necessary to implement systems and methods for virtual resource and location-based advertisement. For example, virtual resource data store 280 may include a database for storing data for a plurality of users, a plurality of applications associated with the plurality of users, a plurality of virtual resources associated with the plurality of applications, a plurality of keywords associated with the plurality of virtual resources, a plurality of advertisements associated with the plurality of keywords and the plurality of virtual resources, and a plurality of advertisers associated with the plurality of advertisements. Data for the plurality of advertisers includes at least one advertiser location. One of ordinary skill in the art would recognize that any data store capable of storing the required information to implement systems and methods for virtual resource and location-based advertisement are within the spirit and scope of the invention.

In one or more embodiments, one or more applications stored in virtual resource data store 208 include one or more games, including online games. One or more virtual resource stored in virtual resource data store 208 may include one or more in-game resources. An in-game resource includes any virtual resource belonging to one or more players in one or more game applications.

Virtual resource server 202 also includes advertisement module 212. Advertisement module 212 is configured to obtain at least one advertisement including an offer from at least one advertiser. The offer includes an exchange of virtual resources. An exchange of virtual resources may involve any method for increasing or decreasing the level of one or more virtual resources of at least one user. For example, an offer may include an exchange of at least one specified virtual resource for goods and services, an exchange of at least one specified virtual resource for a discount on goods and services, an exchange of at least one specified virtual resource for a chance to win goods and services, discounts, and other prizes, and any other exchange involving a virtual resource.

In one or more embodiments, an offer includes an exchange of at least one specified virtual resource for visiting an associated advertiser location. The visit may be automatically detected by location information received from a user device, such as GPS information. The visit may also be detected using a physical or virtual token distributed to the user at the advertiser location, such as a bar code, a password, a key code, or any other token. In one or more embodiments, a user may register the visit at a computer system or another machine located physically at the advertiser location.

In one or more embodiments, an offer includes an exchange of at least one specified virtual resource for visiting at least one specified virtual location, such by calling or texting a virtual location over telephone network, visiting a uniform resource identifier (URI) on a network including the Internet, viewing an advertisement over any medium, or any other method for accessing virtual information. The offer may include an exchange of at least one specified virtual resource for providing user information to an associated advertiser, including but not limited to demographic information, personal information, market testing information, or any other information provided by the user.

Advertisement module 212 is further configured to obtain at least one advertiser location of the at least one advertiser. The at least one advertiser location may be used to determine selected offers to provide based on at least one keyword and a distance from a user location to the at least one advertiser location.

Advertiser module 212 may access and modify advertiser and advertisement information and any other associated information stored in virtual resource data store 208.

Virtual resource server 202 also includes advertiser interface 214. Advertiser interface 214 is configured provide an interface to advertisement module 212. Advertiser interface 214 may be accessed by one or more advertiser clients 224-226, such as over network 216. Advertiser interface 214 may include an application programming interface (API), a web interface, or any other interface for providing access to advertisement module 212 to one or more advertisers.

Advertiser interface 214 may present one or more advertiser clients 224-226 with available keyword information and virtual resource information stored in virtual resource data store. In one or more embodiments, advertiser interface 214 allows an advertiser to request a keyword and virtual resource when either of the requested keyword and the requested virtual resource are not yet present in virtual resource data store 208.

Although a software implementation of advertiser interface 214 is shown, one of ordinary skill in the art would recognize that an internal user of virtual resource server 202 may serve as a human contact point to advertisers 224-226 without departing from the spirit and scope of the invention.

Virtual resource server 202 may include optional keyword management module 210. Keyword management module 210 is configured to associate virtual resources with keywords independently of advertisement module 212. Keyword management module 210 may access and modify keyword information and any other associated information stored in virtual resource data store 208.

In one or more embodiments, keyword management module 210 automatically generates one or more keywords and associates the keywords with one or more virtual resources. The automatically generated keywords may be generated based on one or more virtual resource identifiers for one or more virtual resources in one or more applications 228. An operator may also evaluate one or more applications 228 to select one or more keywords to generate and associate with the one or more applications 228. Keywords generated by keyword management module 210 may be provided to one or more advertisers, such as through advertiser interface 214, as potential keywords to use in one or more advertisements.

Virtual resource server 202 also includes user search module 204 and user search interface 206. User search module 204 is configured to provide one or more offers to user devices 218-222 through user search interface 206. User search interface 206 may be accessed by one or more users via user devices 218-222. User devices 218-222 access user search interface 206 through a network, such as network 216. User devices 218-222 may include any device capable of running one or more applications. In one or more embodiments, user devices 218-222 include at least one mobile device, such as a cellular telephone, portable computer, laptop, tablet PC, smartphone, PDA, or any other user device.

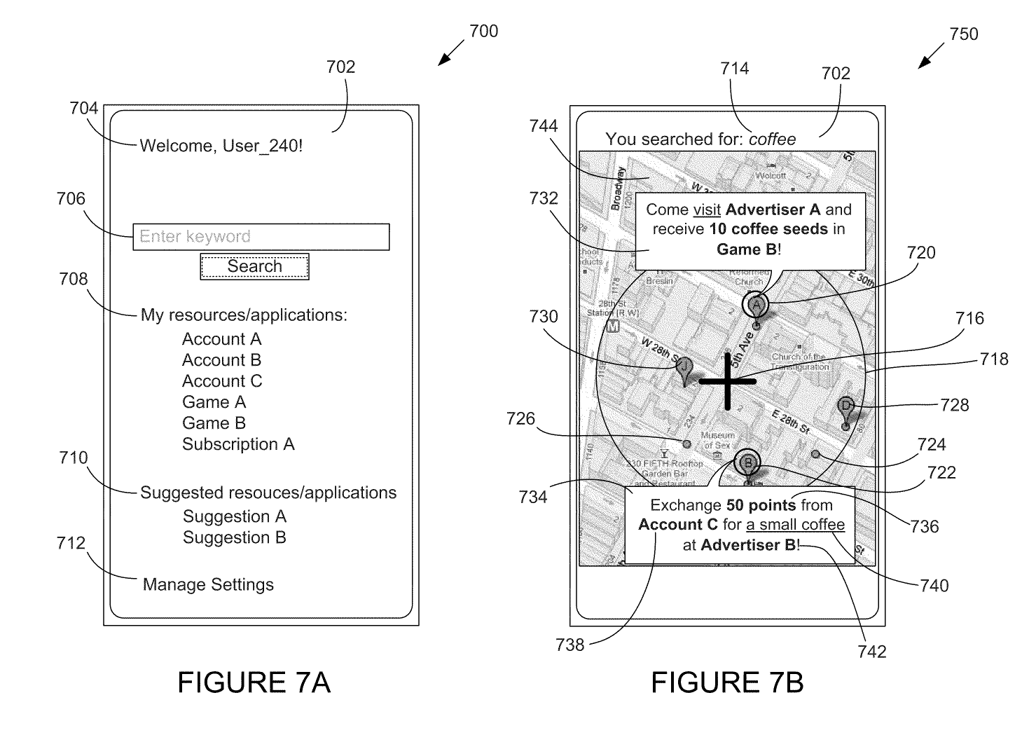

User search interface 206 may include a web interface, a mobile web interface, a standalone client, a cellular telephone application (“ap”), or any other interface to provide access to user search module 204 to one or more user devices 218-222. In one or more embodiments, user search interface 206 includes two or more different user search interfaces. The user search interface provided to a specific user device depends on the type of network 216 used for communication between the specific user device and user search interface 206. An exemplary user search interface is described in further detail in FIG. 7.

User search module 204 is further configured to receive user identification information, a user location, and a selected keyword from a user device. The user identification information, user location and selected keyword may be obtained from one or more user devices 218-222 through user search interface 206.

User search module 204 is further configured to obtain data from virtual resource data store 208. The data includes at least one selected virtual resource level associated with at least one selected virtual resource, where the selected virtual resource is associated with the selected keyword. The data also includes at least one selected advertiser associated with the selected keyword based on a distance between the user location and at least one advertiser location. The data also includes at least one selected offer associated with the at least one selected advertiser and the selected keyword.

User search module 204 is further configured to determine at least one selected offer associated with the selected keyword based on a distance between the user location and the at least one advertiser location, where at least one selected offer includes an exchange of at least one selected virtual resource from at least one selected advertiser. In one or more embodiments, user search module 204 is configured to determine a selected offer based on whether a virtual resource level of a user is non-zero. User search module 204 may also be configured to determine a selected offer based on whether a virtual resource level of a user is at least an amount specified by an offer.

User search module 204 is further configured to provide the at least one selected offer, the at least one selected advertiser, and the at least one selected advertiser location to a user device. Selected offers, selected advertisers, and selected advertiser locations may be provided to one or more user devices 218-222 over users search interface 206.

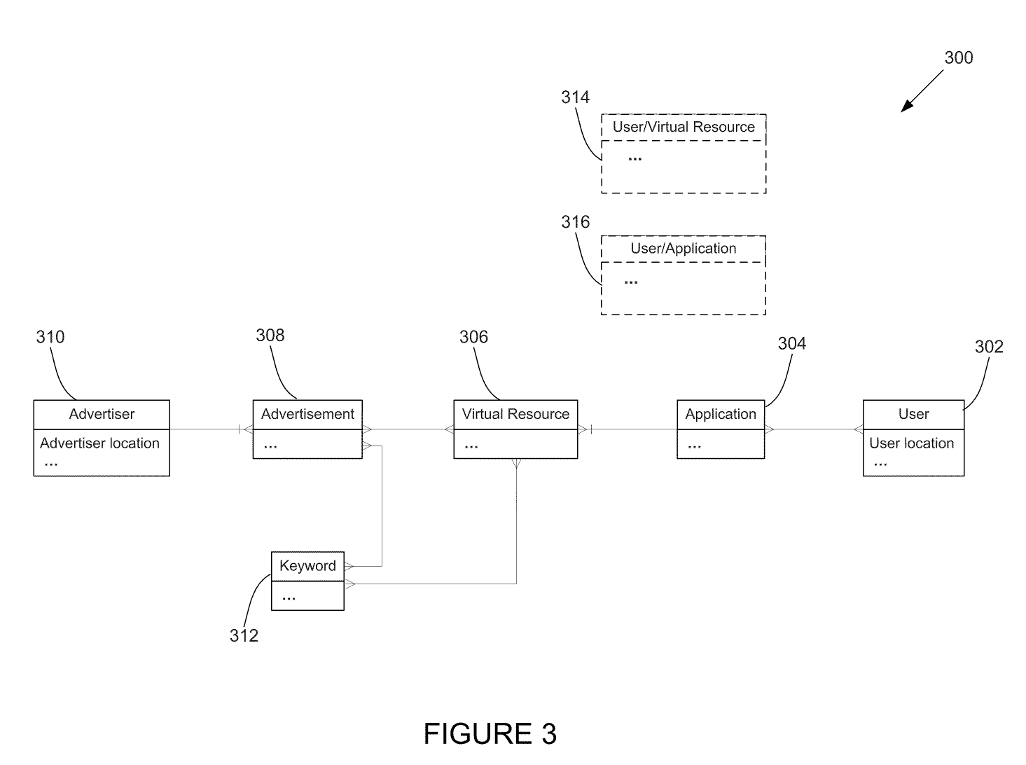

FIG. 3 illustrates an exemplary entity relationship diagram outlining a database 300 in accordance with systems and methods for virtual resource and location-based advertisement. Database 300 may be a flat, relational, network, object, hierarchical, or any other kind of database capable of implementing systems and methods for virtual resource and location-based advertisement. Database 300 may include one or more software applications supporting access to data stored in database 300, such as a database management system. One of ordinary skill in the art would recognize that although a basic structure for a database schema is outlined in diagram 300, any database with a structure or schema capable of storing the required information to implement systems and methods for virtual resource and location-based advertisement are within the spirit and scope of the invention.

Database 300 includes user domain object 302. User domain object 302 includes user data, such as user location data and other user data. A user may be associated with a plurality of applications.

Database 300 further includes application domain object 304. Application domain object 304 includes application data. An application may be associated with a plurality of users. An application may also be associated a plurality of virtual resources. In one or more embodiments, one or more applications stored in database 300 include one or more games, including online games.

Database 300 further includes virtual resource domain object 306. Virtual resource domain object 306 includes virtual resource data. A virtual resource may be associated with an application. A virtual resource may also be associated with a plurality of keywords. A virtual resource may also be associated with a plurality of advertisements. In one or more embodiments, one or more virtual resources stored in database 300 includes one or more in-game resources. An in-game resource includes any virtual resource belonging to one or more players in one or more game applications.

Database 300 further includes advertisement domain object 308. Advertisement domain object 308 includes advertisement data, such as an offer associated with a keyword and an advertiser, and other advertisement data. An advertisement may be associated with a plurality of keywords. At advertisement may also be associated with a plurality of virtual resources. An advertisement may also be associated with any advertiser. In one or more embodiments, advertisements associated with two or more advertisers are also accepted.

Database 300 further includes advertiser domain object 310. Advertiser domain object 310 includes advertiser location data and other advertiser data. In one or more embodiments, an advertiser may have a plurality of advertiser locations. An advertiser may be associated with a plurality of advertisements.

Database 300 further includes keyword domain object 312. Keyword domain object 312 includes keyword data. A keyword may be associated with a plurality of advertisements. A keyword may also be associated with a plurality of virtual resources.

In one or more embodiments, database 300 further includes user/application reference table 314. User/application reference table 314 is a many-to-many reference table specifying specific application data for specific users. Data in user/application reference table 314 may include login information, authentication information, account information, and any other application data specific to a user.

In one or more embodiments, database 300 further includes user/virtual resource reference table 316. User/virtual resource reference table 316 is a many-to-many reference table specifying specific virtual resource data for specific users. Data in user/virtual resource reference table 316 may include a virtual resource level and any other virtual resource data specific to a user.

Although domain objects 302-312 and reference tables 314-316 are shown in exemplary database 300, one of ordinary skill in the art would recognize that any database implementation capable of storing and accessing the required information to implement systems and methods for virtual resource and location-based advertisement are within the spirit and scope of the invention.

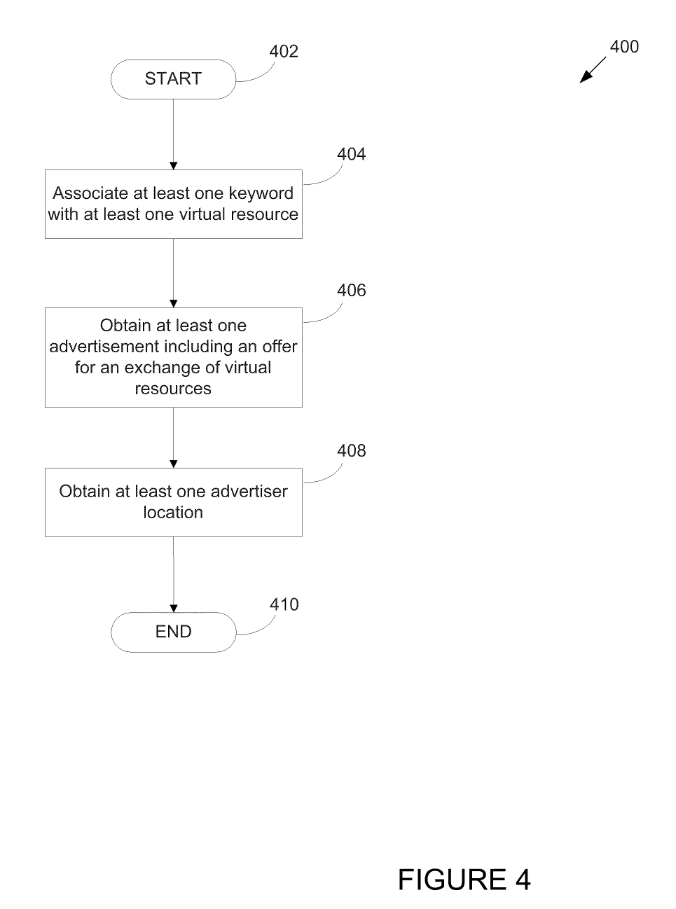

FIG. 4 is a flowchart of an exemplary process for accepting advertisements in accordance with systems and methods for virtual resource and location-based advertisement. Process 400 begins at step 402.

Processing continues to step 404, where at least one keyword is associated with at least one virtual resource. For example, an advertiser may request an keyword to be associated with a virtual resource. A keyword may also be automatically generated and associated with one or more virtual resources, such as by processing one or more virtual resource identifiers for one or more virtual resources in one or more applications.

Processing continues to step 406, where at least one advertisement including an offer for an exchange of virtual resources is obtained. The offer includes an exchange of virtual resources. An exchange of virtual resources may involve any method for increasing or decreasing the level of one or more virtual resources of the user. For example, an offer may include an exchange of at least one specified virtual resource for goods and services, an exchange of at least one specified virtual resource for a discount on goods and services, an exchange of at least one specified virtual resource for a chance to win goods and services, discounts, and other prizes, and any other exchange involving a virtual resource.

In one or more embodiments, an offer includes an exchange of at least one specified virtual resource for visiting an associated advertiser location. The visit may be automatically detected by location information received from a user device, such as GPS information. The visit may also be detected using a physical or virtual token distributed to the user at the advertiser location, such as a bar code, a password, a key code, or any other token. In one or more embodiments, a user may register the visit at a computer system or another machine located physically at the advertiser location.

In one or more embodiments, an offer includes an exchange of at least one specified virtual resource for visiting at least one specified virtual location, such by calling or texting a virtual location over telephone network, visiting a uniform resource identifier (URI) on a network including the Internet, viewing an advertisement over any medium, or any other method for accessing virtual information. The offer may include an exchange of at least one specified virtual resource for providing user information to an associated advertiser, including but not limited to demographic information, personal information, market testing information, or any other information provided by the user.

Processing continues to step 408, where at least one advertiser location is obtained. In one or more embodiments, an advertiser may have a plurality of advertiser locations.

Processing continues to step 410, where process 400 terminates.

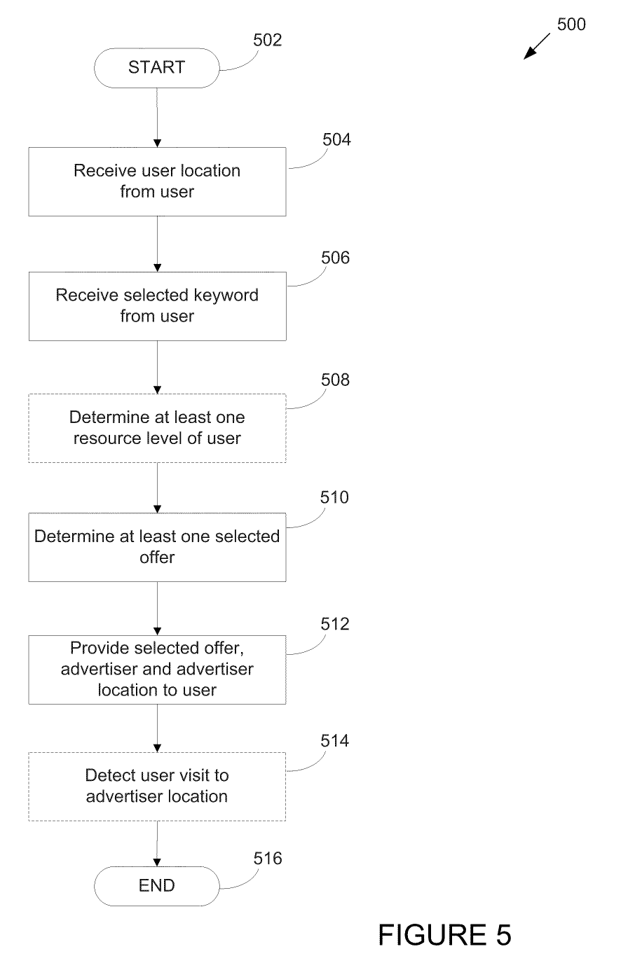

FIG. 5 is a flowchart of an exemplary process for providing location-based keyword advertisements in accordance with systems and methods for virtual resource and location-based advertisement. Process 500 begins at step 502.

Processing continues to step 504, where a user location is received from a user. In one or more embodiments, one or more stored user locations are associated with a user's account, such as a home location, a work location, one or more custom locations, and any other stored location. A path, such as a commuting path, may also be entered as a user location. In one or more embodiments, the user location is a current location of the user. The current location of the user may be periodically received from a GPS-enabled mobile device.

Processing continues to step 506, where a selected keyword is received from the user. A user interface may be provided to the user to enter one or more selected keywords on a user device.

Processing continues to optional step 508, where at least one virtual resource level of the user is determined. Authentication information provided by a user may be required to determine the at least one virtual resource level in one or more applications. Alternatively, global virtual resource level information for one or more applications may be available without requiring authentication from each user.

Processing continues to step 510, where at least one selected offer is determined. At least one selected offer is determined based on association with the selected keyword and a distance between the user location and at least one advertiser location. The at least one selected offer includes an exchange of at least one selected virtual resource from at least one selected advertiser.

Processing continues to step 512, where the selected offer, advertiser and advertiser location are provided to the user. The selected offer, advertiser and advertiser location may be provided graphically on a map as an extension of an existing mapping application and/or through a web interface, a mobile web interface, a standalone client, a cellular telephone application (“ap”), or any other interface.

Processing continues to optional step 514, where a user visit to an advertiser location is detected. The user visit may be automatically detected by location information received from the user, such as GPS information generated by a user device. The visit may also be detected using a physical or virtual token distributed to the user at the advertiser location, such as a bar code, a password, a key code, or any other token. In one or more embodiments, a user may register the visit at a computer system or another machine located physically at the advertiser location.

Processing continues to step 516, where process 500 terminates.

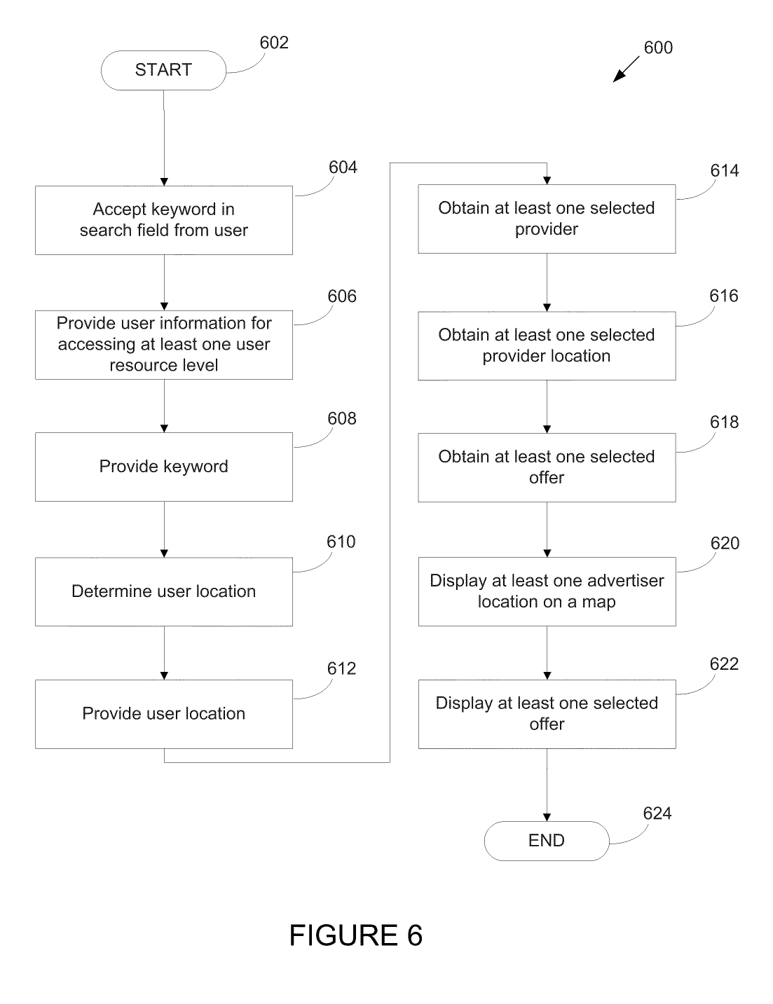

FIG. 6 is a flowchart of an exemplary process for location-based keyword searching in accordance with systems and methods for virtual resource and location-based advertisement. Process 600 begins at step 602.

Processing continues to step 604, where a keyword is accepted in the search field from a user. Processing continues to step 606, where user information for accessing at least one user virtual resource level is provided. Processing continues at step 608, where the keyword is provided. Processing continues to step 610, where a user location is determined. Processing continues to step 612, where the user location is provided. Processing continues to step 614, where at least one selected provider is obtained. Processing continues to step 616, where at least one selection provider location is obtained. Processing continues to step 618, where at least one selected offer is obtained. Processing continues to step 620, where at least one advertiser location is displayed on a map. Processing continues to step 622, where at least one selected offer is displayed. Processing continues to step 624, where process 600 terminates.

FIG. 7A illustrates an exemplary search user interface (UI) in accordance with systems and methods for virtual resource and location-based advertisement. Search UI 700 may be presented on display 702 of a user device, such as a mobile device, including a cellular telephone, portable computer, laptop, tablet PC, smartphone, PDA, or any other user device.

Search UI 700 provides an interface for a user to enter at least one keyword, such as in keyword field 706. The at least one keyword may be input using any input device of the user device.

Search UI 700 may also display user login information 704 after a user logs in. The user may log in through a login interface (not shown) requiring user authentication to a system implementing systems and methods for virtual resource and location-based advertisement.

Search UI 700 may also display linked resource list 708. Linked resource list 708 includes at least one application associated with the user's account. In one or more embodiments, linked resource list 708 includes at least one virtual resource associated with the user's account. Each listed application or virtual resource may include a hyperlink, shortcut, tool tip, or any other means of accessing account information and/or settings associated with the application or virtual resource. In one or more embodiments, the settings for each application include authentication information for a user to access levels of virtual resources associated with the application. Alternatively, a system for virtual resource and location-based advertisement may have global access to virtual resource level information for registered users directly through the application without requiring individual user authentication.

Search UI 700 may also display suggested resource list 710. Suggested resource list 710 includes at least one suggested application. The at least one suggested application may include applications submitted to the system for virtual resource and location-based advertisement as a paid application advertisement. The at least one suggested application may also include applications related to registered application of the user, such as applications sharing an owner or a developer. The at least one suggested application may also include applications selected based on at least one of a user's history, identified interests, demographic information, marketing information, group associations, or any other method of identifying a suggested application of potential interest to the user.

In one or more embodiments, suggested resource list 710 includes at least one suggested virtual resource. The at least one suggested virtual resource may include a virtual resource submitted as a paid advertisement for an application associated with the virtual resource. The at least one suggested virtual resource may also include virtual resources selected based on at least one of a user's history, identified interests, demographic information, marketing information, group associations, or any other method of identifying a suggested virtual resource of potential interest to the user. The at least one suggested virtual resource may also include virtual resources of applications that the user is previously associated with.

Search UI 700 may also include a management interface 712 for managing user account settings. Management interface 712 may include one or more hyperlinks, shortcuts, tool tips, or any other interface for managing one or more account settings.

FIG. 7B illustrates an exemplary results user interface (UI) in accordance with systems and methods for virtual resource and location-based advertisement. Results UI 750 may be presented on display 702 of a user device, such as a mobile device, including a cellular telephone, portable computer, laptop, tablet PC, smartphone, PDA, or any other user device.

In one or more embodiments, results UI 750 is an extension of an existing mapping application, including an existing application for locating providers of goods and services based on a keyword search. Results UI 750 may also be presented through a web interface, a mobile web interface, a standalone client, a cellular telephone application (“ap”), or any other interface.

The user device is configured to obtain information displayed in results UI 750 over a network in response to a keyword search entered by the user in search UI 700. Results UI 750 may display the selected keyword 714 entered by the user in search field 706.

The information obtained is also based on a user location provided by the mobile device. The information may also be based on authentication information for accessing at least one user virtual resource level. In one or more embodiments, the authentication information is stored on either the user device or a server.

Results UI 750 further includes map area 744. Map area 744 includes user location 716 and search area 718. Search area 718 defines an area searched for providers of goods and services relative to user location 716. In one or more embodiments, one or more user location 716 may be associated with a user's account, such as a home location, a work location, one or more custom locations, and any other location. A path, such as a commuting path, may also be entered as a user location. In one or more embodiments, user location 716 is a current location of the user. The current location of the user may be periodically received from a GPS-enabled mobile device.

Results UI 750 is configured to display the at least one selected offer 732-734 associated with an at least one selected advertiser. Selected offers 732-734 are determined based on selected keyword 714 and a distance between user location 716 and at least one advertiser location associated with selected offers 732-734. At least one selected offer 732-734 associated with selected keyword 714 may be determined based on a distance between the user location and at least one advertiser location. The distance may be based on a radius, a drawn area, a commuting time via walking, driving, or public transportation, and any other method of determining a distance from user location 716.

In one or more embodiments, selected offers 732-734 include an offer for an exchange of at least one selected virtual resource from at least one selected advertiser. For example, selected offer 734 may include an exchange of a quantity of a virtual resource 736 associated with application 738 for goods and services 740 at the advertiser location advertiser 742 displayed in map area 744. An exchange may involve any method for increasing or decreasing the level of one or more selected virtual resources of the user.

Selected offers 732-734 may include an exchange of at least one specified virtual resource for goods and services, an exchange of at least one specified virtual resource for a discount on goods and services, an exchange of at least one specified virtual resource for a chance to win goods and services, discounts, and other prizes, and any other exchange involving a virtual resource.

In one or more embodiments, selected offers 732-734 may include an exchange of at least one specified virtual resource for visiting an associated advertiser location. The visit may be automatically detected by location information received from the user, such as GPS information generated by a user device. The visit may also be detected using a physical or virtual token distributed to the user at the advertiser location, such as a bar code, a password, a key code, or any other token. In one or more embodiments, a user may register the visit at a computer system or another machine located physically at the advertiser location.

In one or more embodiments, selected offers 732-734 include an exchange of at least one specified virtual resource for visiting at least one specified virtual location, such by calling or texting a virtual location over telephone network, visiting a uniform resource identifier (URI) on a network including the Internet, viewing an advertisement over any medium, or any other method for accessing virtual information. Selected offers 732-734 may include an exchange of at least one specified virtual resource for providing user information to an associated advertiser, including but not limited to demographic information, personal information, market testing information, or any other information provided by the user.

Results UI 750 may be further configured to display general results 720-730 indicating one or more providers of goods and services associated with the selected keyword that are located within search area 718 other than advertisers in a system for virtual resource and location-based advertisement.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable medium having computer-readable instructions for virtual resource and location-based advertisement, wherein execution of said computer-readable instructions by one or more processors causes said one or more processors to carry out the steps of:
associating at least one keyword with at least one virtual resource in at least one application;
obtaining at least one advertisement comprising an offer, wherein said offer comprises an exchange of virtual resources from at least one advertiser;
obtaining at least one advertiser location of said at least one advertiser;
receiving a user location and a selected keyword from a user;
determining at least one selected offer associated with said selected keyword based on a distance between said user location and said at least one advertiser location, wherein said at least one selected offer comprises an exchange of at least one selected virtual resource from at least one selected advertiser; and
providing said at least one selected offer, said at least one selected advertiser, and at least one selected advertiser location associated with said at least one selected advertiser to said user.

2. The computer-readable medium of claim 1, wherein said at least one virtual resource comprises at least one in-game resource and wherein said at least one application comprises at least one game.

3. The computer-readable medium of claim 1, wherein determining said at least one selected offer further comprises determining if a virtual resource level of said user for a virtual resource associated with an offer is non-zero.

4. The computer-readable medium of claim 1, wherein determining said at least one selected offer further comprises determining if a virtual resource level of said user for a virtual resource associated with a offer is at least an amount specified by said offer.

5. The computer-readable medium of claim 1, wherein said offer comprises an exchange of at least one specified virtual resource for at least one of goods and services.

6. The computer-readable medium of claim 1, wherein said offer comprises an exchange of at least one specified virtual resource for a discount on least one of goods and services.

7. The computer-readable medium of claim 1, wherein said offer comprises an exchange of at least one specified virtual resource for a chance to win at least one of goods, services, discounts and other prizes.

8. The computer-readable medium of claim 1, wherein said offer comprises an exchange of at least one specified virtual resource for visiting an associated advertiser location by said user.

9. The computer-readable medium of claim 8, wherein said visiting an associated advertiser location is automatically detected by location information received from said user.

10. The computer-readable medium of claim 8, wherein said visiting an associated advertiser location is tracked using a token distributed to said user at said associated advertiser location.

11. The computer-readable medium of claim 1, wherein said offer comprises an exchange of at least one specified virtual resource for visiting a virtual location by said user.

12. The computer-readable medium of claim 1, wherein said offer comprises an exchange of at least one specified virtual resource for viewing an advertisement by said user.

13. The computer-readable medium of claim 1, wherein said offer comprises an exchange of at least one specified virtual resource for providing user information to an associated advertiser.

14. The computer-readable medium of claim 1, wherein said user location is periodically received from a GPS-enabled mobile device.

15. The computer-readable medium of claim 1, wherein an automatically generated keyword is automatically associated with a virtual resource based on a virtual resource identifier.

16. The computer-readable medium of claim 1, wherein a requested keyword is associated with a requested virtual resource based on a request by a requesting advertiser.

17. A computer-readable medium having computer-readable instructions for virtual resource and location-based advertisement, wherein execution of said computer-readable instructions by one or more processors causes said one or more processors to carry out the steps of:
accepting user input comprising a keyword in a search field from a user;
providing said keyword over a network;
providing authentication information over said network, wherein said authentication information enables access to at least one user virtual resource level of a virtual resource in an application comprising said virtual resource;
determining a user location;
providing said user location over said network;
obtaining at least one selected advertiser over said network, wherein said at least one selected advertiser is determined based on said keyword and said user location;
obtaining at least one selected advertiser location over said network;
obtaining at least one selected offer associated with said at least one selected advertiser comprising an offer to exchange at least one selected virtual resource associated with said keyword;
displaying said at least one selected advertiser to said user on a map based on said at least one selected advertiser location; and
displaying said at least one selected offer to said user.

18. The computer-readable medium of claim 17, wherein said computer-readable instructions are configured to execute a client program to carry out said steps on a mobile device.

19. The computer-readable medium of claim 17, wherein said computer-readable instructions are configured to execute as an extension of an existing mapping application.

20. A system for associating virtual resource and location-based advertisement comprising:
a virtual resource data store comprising a computer database configured to store data comprising a plurality of users, a plurality of applications associated with said plurality of users, a plurality of virtual resources associated with said plurality of applications, a plurality of keywords associated with said plurality of virtual resources, a plurality of advertisements associated with said plurality of keywords and said plurality of virtual resources, and a plurality of advertisers associated with said plurality of advertisements, wherein each of said plurality of advertisers comprise at least one advertiser location;
at least one processor;
a network interface device configured to communicate with a plurality of user devices over a network;
an advertisement module comprising a computer-readable medium comprising computer-readable instructions, wherein execution of said computer-readable instructions by said at least one processor causes said at least one processor to obtain at least one advertisement comprising an offer comprising an exchange of virtual resources from at least one advertiser, and obtain at least one advertiser location of said at least one advertiser;
a user search module comprising a computer-readable medium comprising computer-readable instructions, wherein execution of said computer-readable instructions by said at least one processor causes said at least one processor to:
receive user identification information, a user location and a selected keyword from a user device;
obtain data from said computer database comprising at least one selected virtual resource level associated with at least one selected virtual resource, wherein said at least one selected virtual resource is associated with said selected keyword;
obtain data from said computer database comprising at least one selected advertiser associated with said selected keyword based on a distance between said user location and said at least one advertiser location;
obtain data from said computer database comprising at least one selected offer associated with said at least one selected advertiser and said selected keyword; and
provide said at least one selected offer and said at least one selected advertiser and at least one selected advertiser location associated with said at least one selected advertiser to said user device.
